(19) United States
(12) Patent Application Publication
(10) Pub. No.: US 2015/0212530 A1
(43) Pub. Date: Jul. 30, 2015

(54) LOW DROPOUT VOLTAGE REGULATOR AND METHOD

(71) Applicant: Semiconductor Components Industries, LLC, Phoenix, AZ (US)

(72) Inventor: Jiri Forejtek, Tyniste nad Orlici (CZ)

(21) Appl. No.: 14/594,451

(22) Filed: Jan. 12, 2015

Related U.S. Application Data
(60) Provisional application No. 61/933,046, filed on Jan. 29, 2014.

(51) Int. Cl. G05F 1/56

(52) U.S. Cl. CPC G05F 1/56

(57) ABSTRACT

In accordance with an embodiment, a low dropout voltage regulator includes an error amplifier connected to an output driver. The error amplifier has an output connected to an input of the output driver and an input connected to an input of the output driver. The output driver has an input coupled for receiving an input signal. In accordance with another embodiment, a method for regulating a voltage is provided that includes operating a voltage regulator under control of an output voltage regulation loop in response to the voltage regulator not being in a low dropout region. The voltage regulator is operated under control of a quiescent current regulation loop in response to the voltage regulator being in a low dropout region.

### BACKGROUND

The present invention relates, in general, to electronics and, more particularly, to low dropout voltage regulators.

There are various known types of voltage regulators for power management systems, including both linear regulators and switch mode regulators. One particularly useful type of regulator is referred to as a low dropout (LDO) voltage regulator. LDO voltage regulators can operate correctly even when the input voltage is only about 0.5 volts higher than the regulated output voltage, and thus the LDO voltage regulators are particularly useful for high efficiency power management systems like battery operated devices. A typical LDO voltage regulator includes a voltage reference such as a bandgap voltage reference circuit, an error amplifier, and an output voltage divider. The error amplifier changes the output voltage to make the divided output voltage equal to the reference voltage, and typically includes a pass transistor between the input and output voltage terminals.

Because LDO voltage regulators are useful in such a large number of portable applications, semiconductor manufacturers have sought ways to reduce their sizes while maintaining their ability to control large output circuit elements such as a pass transistor. Techniques for reducing the sizes of LDO voltage regulators have resulted in a large increase in their quiescent currents, which reduces their suitability for portable applications because of an increased power drain.

Accordingly, it would be advantageous to have an LDO voltage regulator and method for regulating an output voltage in which the LDO voltage regulator is configured to have a small form factor with a reduced quiescent current. It would be of further advantage for the LDO voltage regulator and method to be cost efficient to implement.

### BRIEF DESCRIPTION OF THE DRAWINGS

The present invention will be better understood from a reading of the following detailed description, taken in conjunction with the accompanying drawing figures, in which like reference characters designate like elements and in which:

FIG. 1 is a circuit schematic of an LDO voltage regulator in accordance with an embodiment of the present invention;

FIG. 2 is a graph of various currents and voltages versus an input voltage of the LDO voltage regulator of FIG. 1 in accordance with an embodiment of the present invention;

FIG. 3 is a graph of various currents and voltages versus an output current of the LDO voltage regulator of FIG. 1 in accordance with an embodiment of the present invention;

FIG. 4 is a graph of quiescent current versus an input voltage of the LDO voltage regulator of FIG. 1 in accordance with an embodiment of the present invention; and

FIG. 5 is a circuit schematic of an LDO voltages regulator in accordance with another embodiment of the present invention.

For simplicity and clarity of illustration, elements in the figures are not necessarily to scale, and the same reference characters in different figures denote the same elements. Additionally, descriptions and details of well-known steps and elements are omitted for simplicity of the description. As used herein current carrying electrode means an element of a device that carries current through the device such as a source or a drain of an MOS transistor or an emitter or a collector of a bipolar transistor or a cathode or anode of a diode, and a control electrode means an element of the device that controls current flow through the device such as a gate of an MOS transistor or a base of a bipolar transistor. Although the devices are explained herein as certain N-channel or P-channel devices, or certain N-type or P-type doped regions, a person of ordinary skill in the art will appreciate that complementary devices are also possible in accordance with embodiments of the present invention. It will be appreciated by those skilled in the art that the words during, while, and when as used herein are not exact terms that mean an action takes place instantly upon an initiating action but that there may be some small but reasonable delay, such as a propagation delay, between the reaction that is initiated by the initial action. The use of the word approximately, about, or substantially means that a value of an element has a parameter that is expected to be very close to a stated value or position. However, as is well known in the art there are always minor variances that prevent the values or positions from being exactly as stated. It is well established in the art that variances of up to about ten percent (10%) (and up to twenty percent (20%) for semiconductor doping concentrations) are regarded as reasonable variances from the ideal goal of exactly as described.

It should be noted that a logic zero voltage level (V_{L}) is also referred to as a logic low voltage and that the voltage level of a logic zero voltage is a function of the power supply voltage and the type of logic family. For example, in a Complementary Metal Oxide Semiconductor (CMOS) logic family a logic zero voltage may be thirty percent of the power supply voltage level. In a five volt Translator-Translator Logic (TTL) system a logic low voltage level may be about 0.8 volts, whereas for a five volt CMOS system, the logic zero voltage level may be about 1.5 volts. A logic one voltage level (V_{H}) is also referred to as a logic high voltage level and, like the logic zero voltage level, the logic high voltage level also may be a function of the power supply and the type of logic family. For example, in a CMOS system a logic one voltage may be about seventy percent of the power supply voltage level. In a five volt TTL system a logic one voltage may be about 2.4 volts, whereas for a five volt CMOS system, the logic one voltage may be about 3.5 volts.

### DETAILED DESCRIPTION

Generally, the present invention provides a low dropout voltage regulator and a method for regulating a voltage, wherein the low dropout voltage regulator includes an error amplifier coupled to an output driver, wherein the output driver includes a pass transistor, a quiescent current regulation amplifier, and a current control circuit. The pass transistor forms part of a current mirror and has a drain electrode connected to an inverting input terminal of the quiescent current regulation amplifier and a source electrode connected to a noninverting input terminal of the quiescent current regulation amplifier. In addition, an offset voltage is associated with the quiescent current regulation amplifier. An output terminal of the quiescent current regulation amplifier is connected to the input of the current control circuit.

In accordance with another embodiment, a method for regulating a voltage is provided that comprises operating a voltage regulator under control of an output voltage regulation loop in response to the voltage regulator configured not to be in a low dropout region. The voltage regulator is operated under the control of a quiescent current regulation loop in response to the voltage regulator configured to be in a low dropout region.

In accordance with another embodiment, a method for regulating a voltage is provided wherein in response to operating in a first mode a feedback voltage is compared with a reference voltage to generate comparison signal. A first current is generated in response to the comparison signal and a mirrored current is generated by mirroring the first current, wherein the mirrored current flows towards an output of a voltage regulator. In response to operating in a second mode, a first voltage is generated at the output in response to the mirrored current. A quiescent current amplifier generates a current adjust voltage in response to an input voltage and the first voltage appearing at first and second input terminals of the quiescent current amplifier. The first current is generated in response to the current adjust voltage and the first current is mirrored to form a mirrored current that serves as a drain to source current of a transistor coupled to the output of the voltage regulator.

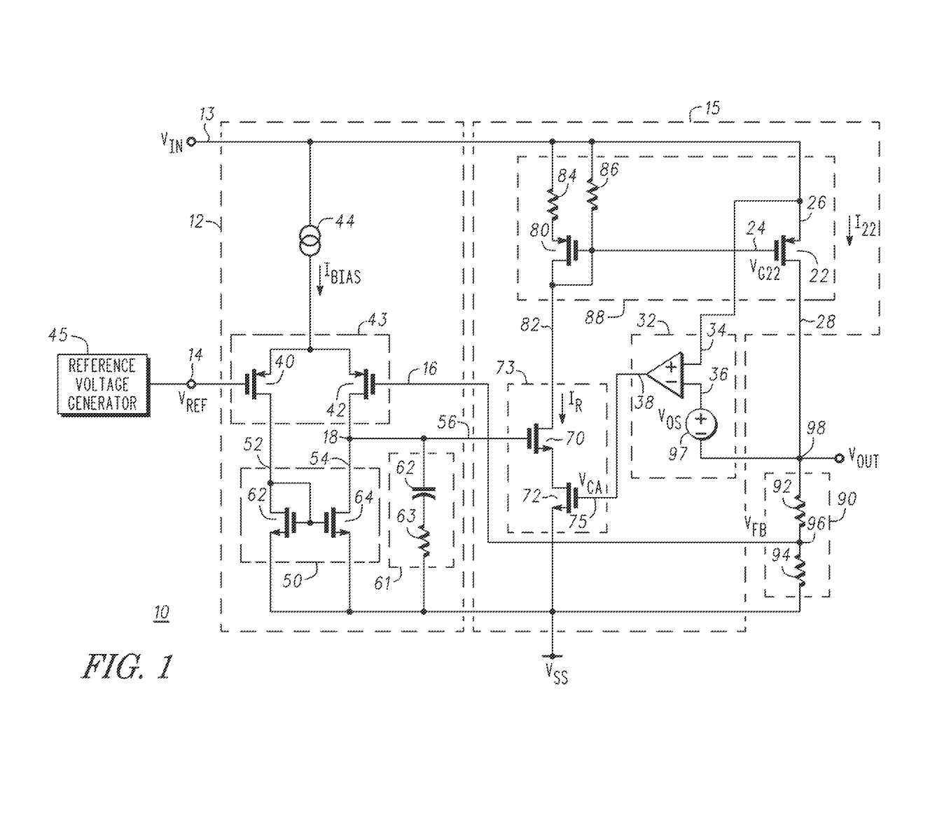

FIG. 1 is a circuit schematic of a low dropout voltage regulator 10 in accordance with an embodiment of the present invention. What is shown in FIG. 1 is an error amplifier 12 coupled to an output driver 15 and a voltage divider network 90 coupled to output driver 15. Error amplifier 12 has an input terminal 14 coupled for receiving a reference voltage, V_{REF}, from a reference voltage generator 45, an input terminal 16 coupled for receiving a feedback voltage, V_{FB}, and an output terminal 18. By way of example, error amplifier 12 includes transistors 40 and 42 configured as a differential pair 43, which differential pair 43 is connected to a current source 44. Transistor 40 has a gate electrode connected to or, alternatively, serving as input terminal 14, transistor 42 has a gate electrode connected to or, alternatively, serving as input terminal 16, and transistors 40 and 42 have source electrodes commonly connected together and to a terminal for receiving a bias current I_{BIAS} from current source 44. Current source 44 is connected between the source electrodes of transistors 40 and 42 and an input terminal 13. The drain electrode of transistor 40 is connected to a terminal 52 of a current mirror 50 and the drain electrode of transistor 42 is connected to a terminal 54 of current mirror 50. Current mirror 50 may be comprised of a pair of field effect transistors 62 and 64 having commonly connected gate electrodes and commonly connected source electrodes, where the gate electrode of transistor 62 is connected to its drain electrode to form terminal 52 of current mirror 50 and the drain electrode of transistor 64 serves as terminal 54 of current mirror 50. The source electrodes of transistors 62 and 64 are coupled for receiving a source of operating potential V_{SS}. By way of example, operating potential V_{SS} is a ground potential. The drain electrodes of transistors 42 and 64 are commonly connected together to form output terminal or output node 18. As discussed above, the gate electrodes of transistors 40, 42, 62, and 64 may be referred to as control electrodes and the drain and source electrodes of transistors 40, 42, 62, and 64 may be referred to as current carrying electrodes.

Error amplifier 12 further includes a frequency compensation network 61 coupled between output terminal 18 and source of operating potential V_{SS}. Frequency compensation network 61 may be comprised of a capacitor 62 and a resistor 63 that are connected in series. It should be noted that the circuit configuration or topology of error amplifier 12 is not a limitation of the present invention.

Reference voltage generator 45 may be, for example, a bandgap reference voltage generator. However, the topology of reference voltage generator 45 is not a limitation of the present invention.

Output driver 15 may be comprised of a current control circuit 73, a current mirror 88, and a quiescent current regulation amplifier 32. In accordance with an embodiment, current mirror 88 includes transistors 22 and 80, where transistor 80 has a source electrode connected to input terminal 13 through a resistor 84 for receiving input voltage V_{IN} and a gate electrode commonly connected to the drain electrode of transistor 80 and to the gate electrode of transistor 22. The commonly connected gate electrode and drain electrode form a terminal 82 of current mirror 88, wherein terminal 82 is connected to a terminal of current control circuit 73. In addition, the commonly connected gate electrodes of transistors 22 and 80 may be coupled for receiving input voltage V_{IN} through a resistor 86. Transistor 22 may be referred to as a pass transistor and it may be a power transistor or a power MOSFET (Metal Oxide Semiconductor Field Effect Transistor). It should be noted that resistors 84 and 86 are optional circuit elements and may be absent or replaced by other circuit elements suitable for stabilizing current mirror 88. For example, resistor 84 may be absent and resistor 86 may be absent or resistor 86 may be replaced by a current source or a network comprising a diode connected MOS (Metal Oxide Semiconductor) transistor connected in series with a resistor. Transistors 22 and 80 and resistors 84 and 86 are configured to form current mirror 88 wherein transistors 22 and 80 are sized such that the ratio of the Width to Length, i.e., (W/L) ratio, of transistor 80 to the (W/L) ratio of transistor 22 is the ratio 1:N, where N is an integer.

The source electrode of transistor 22 is connected to input terminal 13 for receiving input voltage V_{IN} and to a noninverting input terminal 34 of quiescent current regulation amplifier 32 and the drain electrode of transistor 22 is coupled to inverting input 36 of quiescent current regulation amplifier 32. It should be noted that quiescent regulation amplifier 32 is shown as an amplifier 33 having a noninverting input 34 and an inverting input 36, wherein inverting input 36 is connected to a voltage source 97 that represents an offset voltage V_{OS} of amplifier 32. As those skilled in the art will appreciate, amplifiers typically include an offset voltage, which may or may not be shown in a circuit structure. For the sake of completeness the offset voltage V_{OS} is shown in FIG. 1. The output terminal of quiescent voltage regulation amplifier 32 is connected to an input terminal 75 of current control circuit 73. By way of example, current control circuit 73 is comprised of transistors 70 and 72, where transistor 70 has a gate electrode connected to output terminal 18 at a input 56, a drain electrode connected to terminal 82 of current mirror 88 and a source electrode connected to a drain electrode of transistor 72. Input 56 may be referred to as a node, input terminal, or input node. Transistor 72 has a gate electrode which serves as input terminal 75, and which is coupled for receiving a current adjust voltage V_{CA} and a source electrode coupled for receiving source of operating potential V_{SS}. As discussed above, the gate electrodes of transistors 22, 80, 70, and 72 may be referred to as control electrodes, the drain and source electrodes of transistors 22, 80, 70, and 72 may be referred to as current carrying electrodes, and operating potential V_{SS} may be a ground potential.

The drain electrode of transistor 22 is also connected to voltage divider network 90, which may be comprised of series connected resistors 92 and 94, wherein a terminal of resistor 92 is connected to the drain electrode of transistor 22 to form a node 98 which serves as an output of low dropout voltage regulator 10 for transmitting output signal V_{OUT}, and the other terminal of resistor 92 is connected to a terminal of resistor 94 to form a node 96 which is connected to input terminal 16 of error amplifier 12. The other terminal of resistor 94 is coupled for receiving a source of operating potential such as, for example, operating potential V_{SS}. Node 96 may serve as another output of low dropout voltage regulator 10 or as an input/output of low dropout voltage regulator 10.

Although, the noninverting input 34 of quiescent current regulation amplifier 32 is shown as being connected to the source of transistor 22 and the inverting input 36 of quiescent current regulation amplifier 32 is shown as being connected to the drain of transistor 22 through offset voltage V_{OS}, this is not a limitation of the present invention. Inputs 34 and 36 may be connected to other circuit elements suitable for generating voltage V_{CA} at input 75.

In accordance with embodiments of the present invention, low dropout voltage regulator 10 includes two regulation loops: an output voltage regulation loop and a quiescent current regulation loop. In response to low dropout voltage regulator 10 operating under control of the output voltage regulation loop, the drain to source voltage (V_{DS22}) of pass transistor 22 is greater than or higher than offset voltage V_{OS} and voltage V_{CA} at the gate of transistor 72, i.e., at input 75, is set to or tied to input voltage V_{IN}. It should be noted that the on-resistance of transistor 72 is sufficiently small that it does not influence the operation of the output voltage regulation loop. Error amplifier 12 generates a reference current I_{R} in response to comparing voltage V_{REF} that appears at input terminal 14 with voltage V_{FB} that appears at input terminal 16. Current mirror 88 generates a current I₂₂ in response to its mirroring action on current I_{R}. In other words, current I_{R} is amplified and mirrored to pass transistor 22 as drain to source current I₂₂.

When a load is coupled to node 98, a portion of current I₂₂ flows through the load and a portion flows through voltage divider network 90. It should be noted that a portion of current I₂₂ may be 100% of current I₂₂, 0% of current I₂₂, or a percentage between 0% and 100%. When there is no load coupled to node 98, all or substantially all of current I₂₂ flows through voltage divider network 90. Error amplifier 12 operates to maintain feedback voltage V_{FB} at substantially the same voltage level as voltage V_{REF}. Because resistors 92 and 94 are connected in series, the current generated by feedback voltage V_{FB} and resistor 94 also flows through resistor 92. Thus, output voltage V_{OUT} is the sum of voltage V_{SS}, the voltage across resistor 94, and the voltage across resistor 92, i.e., the sum of voltage V_{FB} and the voltage across resistor 92. In response to feedback voltage V_{FB} being lower than reference voltage V_{REF}, error amplifier 12 decreases a voltage V_{G22} appearing at the gate of pass transistor 22 and increases current I_{R}, which increases a current I₂₂ and increases output voltage V_{OUT}. In response to feedback voltage V_{FB} being greater than reference voltage V_{REF}, error amplifier 12 increases voltage V_{G22} appearing at the gate of pass transistor 22 and decreases current I_{R}, which decreases a current I₂₂ and decreases output voltage V_{OUT}.

In response to low dropout voltage regulator 10 operating in a dropout regulation operating mode, i.e., the quiescent current regulation loop operating under light load or no load conditions, quiescent current regulation amplifier 32 senses drain to source voltage V_{DS22} of pass transistor 22 and regulates current I_{R} using transistor 72. When the value of the drain to source voltage V_{DS22} approaches the value of the offset voltage V_{OS} during light load or no load conditions, current regulation amplifier 32 regulates current I_{R} so that the drain to source voltage V_{DS22} of pass transistor 22 becomes equal to offset voltage V_{OS}, thereby reducing the quiescent current of low dropout voltage regulator 10 when a light load or no load is coupled to node 98. Typically a light load is one in which an output current has a value up to about 10% to 15% of the maximum load current for small currents, i.e., currents around 10 milliamps.

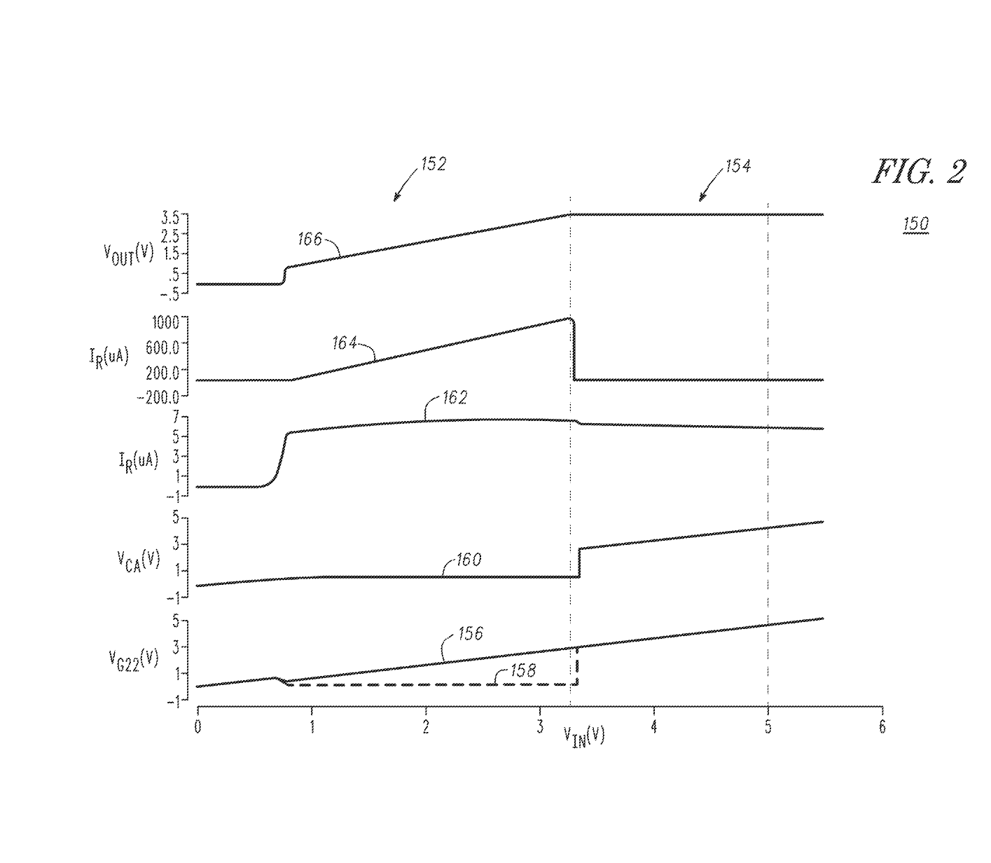

FIG. 2 is a simulation graph 150 that includes plots of voltage and current versus input voltage under no load conditions in accordance with embodiments of the present invention. Simulation graph 150 illustrates operation of low dropout voltage regulator 10 in the dropout regulation region 152, i.e., operation under control of the quiescent current regulation loop, and in the output voltage regulation region 154, i.e., under control of the output voltage regulation loop. Dropout regulation region 152 may be referred to as the dropout operating region and output voltage regulation region 154 may be referred to as the voltage regulation region. In this example, the dropout regulation region occurs for an input voltage V_{IN} ranging from about 0.9 volts to a voltage equal to the sum of the nominal output voltage V_{OUTNOM} and the dropout voltage V_{DROPOUT} and the voltage regulation region occurs for an input voltage V_{IN} that is greater than the sum of the nominal output voltage and the dropout voltage. It should be understood that V_{OUTNOM} is the nominal output voltage for which LDO voltage regulator 10 is designed and V_{OUT} is the present output voltage of the LDO voltage regulator in accordance with a given condition, i.e., the input voltage level, the load, etc. In the dropout region V_{OUT} is less than V_{OUTNOM}. Plot 156 illustrates the voltage V_{G22} at the gate of pass transistor 22 versus input voltage V_{IN}. When LDO regulator circuit 10 operates under control of the quiescent current regulation loop, i.e., in the dropout region, quiescent current regulation amplifier 32, offset voltage V_{OS}, and transistor 72 cooperate to raise gate voltage V_{G22} as input voltage V_{IN} increases thereby keeping drain to source voltage V_{DS22} equal to offset voltage V_{OS} and maintaining current I_{R} at a level that does not cause a large increase the quiescent current.

For the sake of comparison, graph 150 includes a plot 158 illustrating that in a prior art device, gate voltage V_{G22} remains substantially constant as the input voltage V_{IN} increases while operating in the dropout region. Thus, in a prior art device, current I_{R} significantly increases resulting in a large increase in the gate to source voltage of transistor 80 because terminal 82 is held substantially at ground potential. This results in an undesirable increase in the quiescent current. It should be noted that when LDO regulator circuit 10 operates under control of the output voltage regulation loop, i.e., in the output voltage regulation region, gate voltage V_{G22} is increased as input voltage V_{IN} increases.

Plot 160 is a plot of voltage V_{CA} at input 75 versus input voltage V_{IN} in the dropout regulation region and in the output voltage regulation region. During operation in the dropout regulation region, quiescent current regulation amplifier 32 is configured to maintain voltage V_{CA} at a voltage close to the threshold voltage of transistor 72. Under this condition, transistor 72 operates as a voltage controlled current source which limits current I_{R} and gate voltage V_{G22} to values that are sufficient to keep low dropout regulator 10 in regulation. Because quiescent current regulation amplifier 32 is configured to place a voltage substantially equal to voltage V_{IN} at input 75 during operation in the output voltage regulation region, trace 160 illustrates that in this operating region, voltage V_{CA} increases with input voltage V_{IN}.

Plot 162 is a plot of current I_{R} (in microamps, μm) versus input voltage V_{IN} in the dropout regulation region and in the output voltage regulation region in accordance with an embodiment of the present invention. During both low dropout regulation and output voltage regulation, current I_{R} is substantially flat as input voltage V_{IN} is increased.

Plot 164 is included to show that in a prior art device operating in the dropout regulation region, current I_{R} starts at a higher level than that shown in plot 162 and increases to a very high value, i.e., close to 1 milliamp. In this example, current I_{R} of a prior art LDO regulator is more than 100 times higher than in an LDO regulator in accordance with embodiments of the present invention. Thus, the quiescent current of a prior art LDO regulator is very large which is undesirable in portable applications.

Plot 166 shows that in the dropout regulation region the output voltage increases as input voltage V_{IN} increases and in the output voltage regulation region the output voltage remains at the nominal output voltage V_{OUTNOM} as input voltage V_{IN} is increased. It should be noted that plot 166 represents the response for LDO voltage regulators in accordance with embodiments of the present invention and prior art LDO voltage regulators. Because the plots are substantially overlapping, they are shown as a single plot. The voltage difference between the two plots is substantially equal to offset voltage V_{OS} in the dropout regulation region.

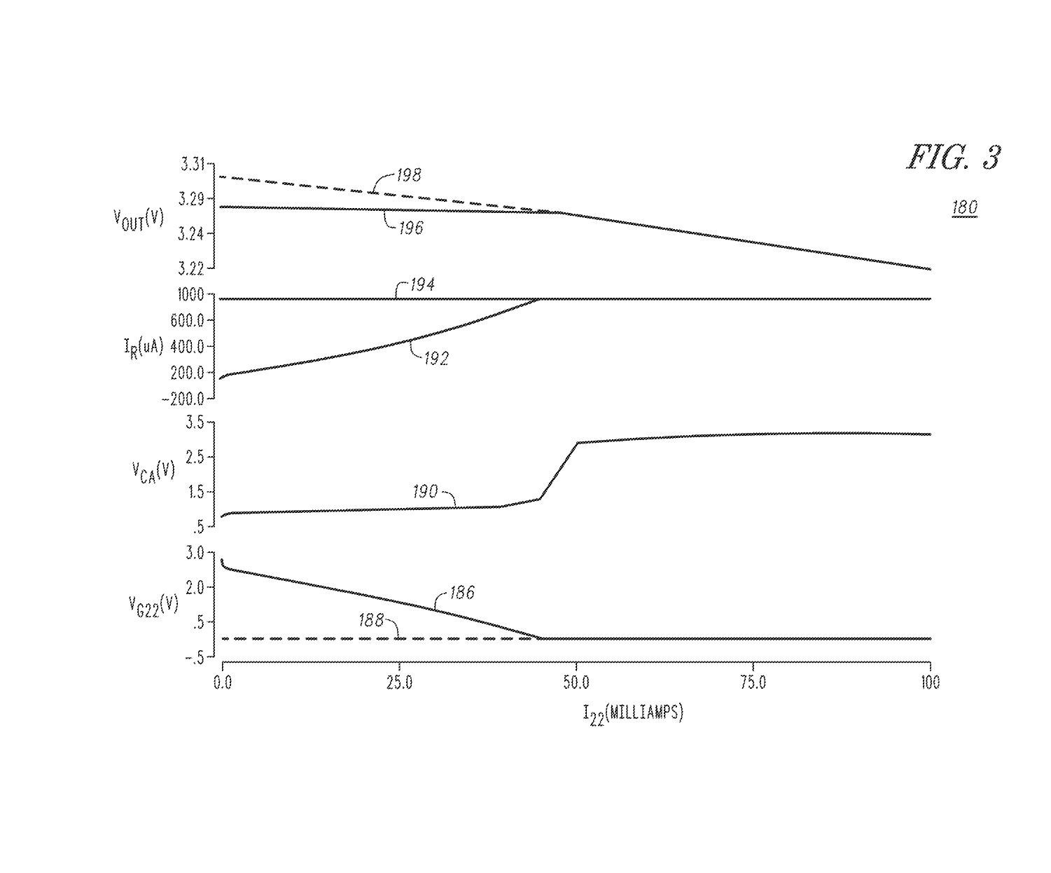

FIG. 3 is a simulation graph 180 that includes plots of voltage and current versus output current in accordance with embodiments of the present invention. FIG. 3 illustrates that the quiescent current regulation loop is active over a range of currents I₂₂. For example, drain to source voltage V_{DS22} of pass transistor 22 increases in response to current I₂₂ increasing. When drain to source voltage V_{DS22} is higher than offset voltage V_{OS} the quiescent current regulation loop is inactive. Simulation graph 180 illustrates operation of low dropout voltage regulator 10 in the dropout regulation region, wherein input voltage V_{IN} is substantially equal to output voltage V_{OUTNOM}. Plot 186 illustrates the voltage V_{G22} at the gate of pass transistor 22 versus current I₂₂. In the dropout regulation region, quiescent current regulation amplifier 32, offset voltage V_{OS}, transistor 72, and transistor 70 cooperate to lower gate voltage V_{G22} as current I₂₂ is increased. For the sake of comparison, simulation graph 180 includes a plot 188 illustrating that in a prior art low dropout voltage regulator, gate voltage V_{G22} remains substantially constant as current I₂₂ is increased in the dropout region. FIG. 3 describes the behavior of the quiescent current regulation loop in response to current I₂₂ being swept over a range of values.

Plot 190 illustrates voltage V_{CA} at input 75 versus current I₂₂ in the dropout regulation region. As discussed with reference to plot 160, during operation in the dropout regulation region, quiescent current regulation amplifier 32 is configured to maintain voltage V_{CA} at a voltage close to the threshold voltage of transistor 72. Under this condition, transistor 72 operates as a voltage controlled current source which limits current I_{R} and gate voltage V_{G22} to values that are sufficient to keep low dropout regulator 10 in regulation.

Plot 192 illustrates current I_{R} (in microamps) versus current I₂₂ (in milliamps) in the dropout regulation region for an LDO voltage regulator in accordance with embodiments of the present invention. Plot 192 shows that current I_{R} is proportional to current I₂₂ as long as the dropout voltage of pass transistor 22 is lower than the offset voltage V_{OS}. Here quiescent current regulation amplifier 32 is actively regulating current I_{R}. The dropout voltage of pass transistor 22 is equal to the product of the resistance Rdson and current I₂₂. Plot 194 illustrates current I_{R} versus current I₂₂ in the dropout regulation region for a prior art LDO voltage regulator. Because current I_{R} for LDO voltage regulators configured in accordance with embodiments of the present invention is less than that for prior art LDO voltage regulators, the quiescent current of LDO voltage regulators is reduced for LDO voltage regulators such as, for example LDO voltage regulator 10 and therefore power consumption is less, which is desirable in portable electronic applications.

Plot 196 shows that in the dropout regulation region the output voltage V_{OUT} remains substantially constant with a value equal to the input voltage minus the offset voltage (V_{IN}−V_{OS}) for small currents when the quiescent current regulation loop is active for LDO voltage regulators configured in accordance with embodiments of the present invention. When the quiescent current regulation loop stops regulating then the output voltage is the same for LDO voltage regulators configured in accordance with embodiments of the present invention and for prior art LDO voltage regulators. Plot 198 shows that in the dropout regulation region the output voltage V_{OUT} decreases as current I₂₂ increases for prior art LDO voltage regulators.

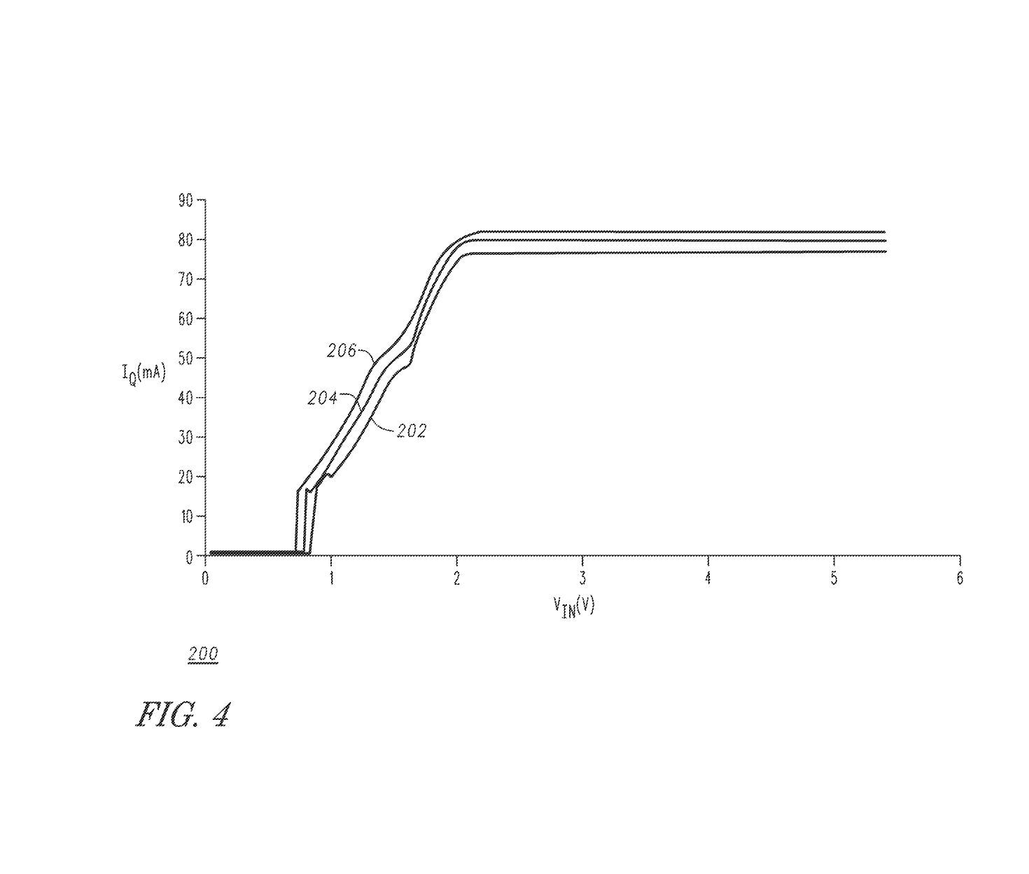

FIG. 4 is a data graph 200 of quiescent current I_{Q} versus input voltage V_{IN} at three temperatures for a nominal output voltage V_{OUTNOM} of 2.8 volts. Plot 202 illustrates quiescent current I_{Q} versus input voltage V_{IN} at −40 degrees Celsius (° C.); plot 204 illustrates quiescent current I_{Q} versus input voltage V_{IN} at 25° C.; and plot 206 illustrates quiescent current I_{Q} versus input voltage V_{IN} at 125° C. In particular, plots 202-206 illustrate that over temperature, LDO voltage regulators configured in accordance with embodiments of the present invention exhibit a substantially flat quiescent current in response to input voltage V_{IN} for LDO voltage regulator 10 operating in the dropout regulation region and operating in the output voltage regulation region.

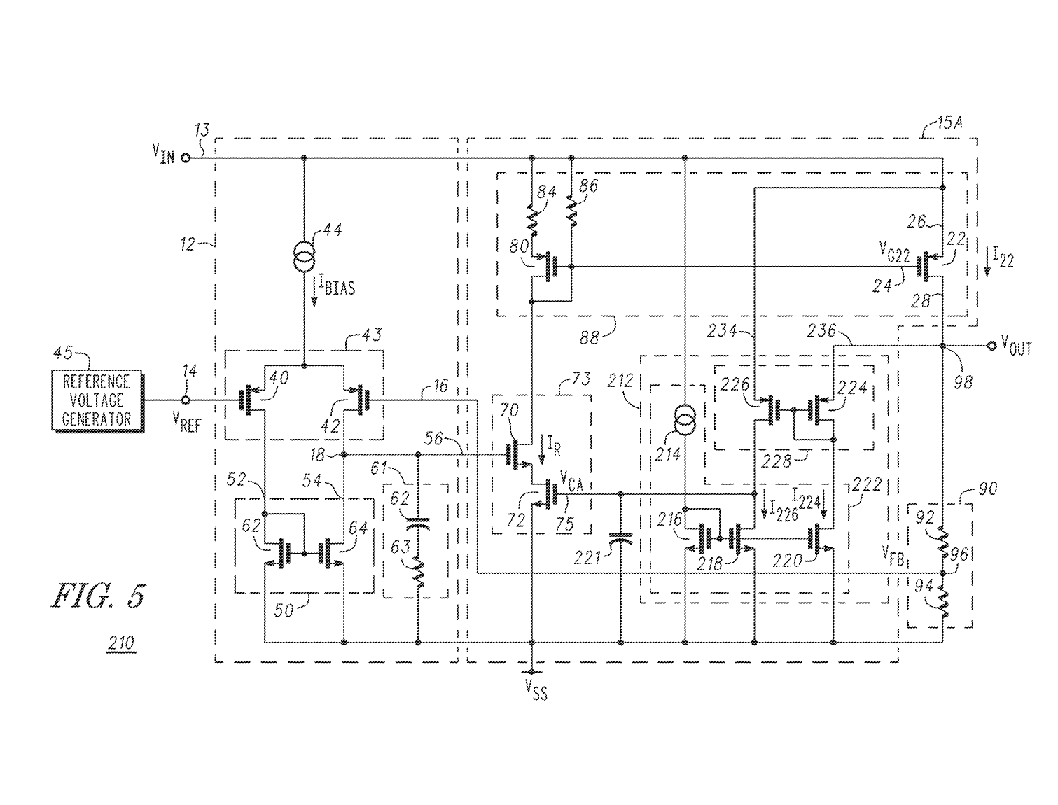

FIG. 5 is a circuit schematic of a low dropout voltage regulator 210 in accordance with another embodiment of the present invention. What is shown in FIG. 5 is an error amplifier 12 coupled to an output driver 15A and a voltage divider network 90 coupled to output driver 15A. Error amplifier 12 has been described with reference to FIG. 1. In addition, current mirror 88, pass transistor 22, and current control circuit 73 of output driver 15A and voltage divider circuit 90 have been described with reference to FIG. 1. Output driver 15A further includes a quiescent current regulation amplifier 212. Because the topology of quiescent current regulation amplifier 212 may be different than that of quiescent current regulation amplifier 32 of FIG. 1, a reference character “A” has been appended to reference character “15” to distinguish these topologies.

Quiescent current regulation amplifier 212 includes current source 214 and transistors 216, 218, and 220 which are configured as a current mirror 222 and transistors 224 and 226 which are configured as a current mirror 228. Current mirror 228 is configured to generate an input differential signal that includes an offset voltage such as offset voltage V_{OS} described with reference to FIG. 1. Transistors 216, 218, and 220 have gates or gate electrodes that are connected together and to the drain electrode of transistor 216. The gate electrodes of transistors 216, 218, and 220 are connected to the drain electrode of transistor 216 and to a terminal of a current source 214. Current source 214 also has a terminal connected to terminal 13 for receiving input voltage V_{IN}. In addition, transistors 216, 218, and 220 have source electrodes that are connected together and coupled for receiving a source of operating potential such as operating potential V_{SS}. By way of example, operating potential V_{SS} is ground potential. Transistors 226 and 224 have gate electrodes that are connected together and to the drain electrode of transistor 224. The drain electrode of transistor 224 is connected to the drain electrode of transistor 220 and the drain electrode of transistor 226 is connected to the drain electrode of transistor 218 and to the gate electrode of transistor 72 at input 75. The source electrode of transistor 224 is connected to drain electrode 28 of pass transistor 22 at node 98 and the source electrode of transistor 226 is connected to the source electrode of pass transistor 22. The source electrodes of transistors 224 and 226 may serve as the input terminals 236 and 234, respectively, of quiescent current regulation amplifier 212. A frequency compensation capacitor 221 is connected between input 75 and source of operating potential V_{SS}. It should be noted that the structure for providing frequency compensation is not limited to being a capacitor. For example, frequency compensation may be accomplished using a frequency compensation network 61 described with reference to FIG. 1 or other suitable frequency compensation structures.

Transistors 224 and 226 are configured such that the width to length (W/L)₂₂₄ ratio of transistor 224 is greater than the width to length ratio (W/L)₂₂₆ of transistor 226 and drain current I₂₂₄ is substantially equal to drain current I₂₂₆. By manufacturing transistors 224 and 226 to have different width to length ratios, (W/L)₂₂₄ and (W/L)₂₂₆, respectively, they have different gate to source voltages during voltage regulation. The difference in the gate to source voltages V_{GS224} and V_{GS226} of transistors 224 and 226, respectively, i.e., (V_{GS226}−V_{GS224}), is substantially equal to the offset voltage, V_{OS}, at inputs 236 and 234 of quiescent current regulation circuit 212. Offset voltage V_{OS} is given by Equation 1 (EQT. 1) as follows:

V_{OS}=V_{GS226}−V_{GS224}=(2*(I_{d}/Kp)^{1/2}*(L₂₂₆/W₂₂₆)^{1/2}−(L₂₂₄/W₂₂₄)^{1/2} EQT. 1

where:

V_{GS226} is the gate to source voltage of transistor 226;

V_{GS224} is the gate to source voltage of transistor 224;

I_{d} is the drain current of transistors 224 and 226;

Kp is a process transconductance parameter for transistors 224 and 226;

L₂₂₆/W₂₂₆ is the reciprocal of the width to length ratio of transistor 226; and

L₂₂₄/W₂₂₄ is the reciprocal of the width to length ratio of transistor 224.

It should be noted that transistor 224 sets a dc operational point of transistor 226 and that transistor 218 serves as an active load for sensing transistor 226.

Like low dropout voltage regulator 10, low dropout voltage regulator 210 includes two regulation loops: an output voltage regulation loop and a quiescent current regulation loop. In response to low dropout voltage regulator 210 operating under control of the output voltage regulation loop, the drain to source voltage (V_{DS22}) of pass transistor 22 is greater than or higher than offset voltage V_{OS} and voltage V_{CA} at the gate of transistor 72 is set to or tied to input voltage V_{IN}. The on-resistance of transistor 72 is sufficiently small that it does not influence the operation of the output voltage regulation loop. Error amplifier 12 generates a reference current I_{R} in response to comparing voltage V_{REF} that appears at input terminal 14 with voltage V_{FB} that appears at input terminal 16. Current mirror 88 generates a current I₂₂ in response to its mirroring action on current I_{R}. In other words, current I_{R} is amplified and mirrored to pass transistor 22 as drain to source current I₂₂.

As discussed above, when a load is coupled to node 98, a portion of current I₂₂ passes through the load and a portion flows through voltage divider network 90. When there is no load coupled to node 98, all or substantially all of current I₂₂ flows through voltage divider network 90. Error amplifier 12 operates to maintain feedback voltage V_{FB} at substantially the same voltage level as voltage V_{REF}. Because resistors 92 and 94 are connected in series, the current generated by feedback voltage V_{FB} and resistor 94 also flows through resistor 92. Thus, output voltage V_{OUT} is the sum of voltage V_{SS}, the voltage across resistor 94, and the voltage across resistor 92, i.e., the sum of voltage V_{FB} and the voltage across resistor 92. In response to feedback voltage V_{FB} being lower than reference voltage V_{REF}, error amplifier 12 decreases a voltage V_{G22} appearing at the gate of pass transistor 22 and increases current I_{R}, which increases current I₂₂ and increases output voltage V_{OUT}. In response to feedback voltage V_{FB} being greater than reference voltage V_{REF}, error amplifier 12 increases voltage V_{G22} appearing at the gate of pass transistor 22 and decreases current I_{R}, which decreases current I₂₂ and decreases output voltage V_{OUT}.

In response to low dropout voltage regulator 210 operating in a dropout regulation operating mode, i.e., when the quiescent current regulation loop operates under light load or no load conditions, quiescent current regulation amplifier 212 senses drain to source voltage V_{DS22} of pass transistor 22 and regulates current I_{R} using transistor 72. When the value of the drain to source voltage V_{DS22} approaches the value of the offset voltage V_{OS} during light load or no load conditions, quiescent current regulation amplifier 212 regulates current I_{R} so that the drain to source voltage V_{DS22} of pass transistor 22 becomes equal to offset voltage V_{OS}, reducing the quiescent current of low dropout voltage regulator 10 when a light load or no load is coupled to node 98. Typically a light load is one in which an output current has a value up to about 10% to 15% of the maximum load current for small currents, i.e., currents around 10 milliamps.

It should be appreciated that error output driver 15 may be implemented using other circuit configurations for current mirror 88, quiescent current regulation amplifiers 32 and 212, and current control circuit 72 without departing from the scope of the present invention.

By now it should be appreciated that a low dropout voltage regulator and a method for regulating an output voltage have been provided. In accordance with embodiments of the present invention, the quiescent current regulation amplifier (32 or 212) senses a drain to source voltage, V_{DS}, of pass transistor 22. In response to drain to source voltage V_{DS} of pass transistor 22 being higher than offset voltage V_{OS}, the low dropout voltage regulator (10 or 210) is controlled by the output voltage regulation loop, wherein the voltage at the input of transistor 72 is set to input voltage V_{IN}. Thus, the quiescent current regulation amplifier (32 or 212) does not influence the output voltage regulation loop or the current consumption of the output buffer (15 or 15A).

In response to a light load, operation in the dropout voltage region, and the output voltage regulation loop controlling the low dropout voltage regulator (10 or 210), the output voltage regulation loop is unbalanced and the drain to source voltage V_{DS} of pass transistor 22 tends towards a low value. In this case the quiescent current regulation amplifier (32 or 212) regulates through transistor 72 the drain to source voltage V_{DS} of the pass transistor 22 to be the value of offset voltage V_{OS}. Thus, the dropout of the LDO is no smaller than offset voltage V_{OS} and the current I_{R} is given by the ratio of the current I₂₂ and the current mirror ratio N, which is determined by transistors 22 and 80.

It should be noted that the output voltage regulation loop includes a path including voltage V_{FB}, input 16 of error amplifier 12, the voltage at input 56 generated in response to comparing feedback voltage V_{FB} with reference voltage V_{REF}, current control circuit 73, current mirror 88, output 98 and output 96, wherein feedback voltage V_{FB} appears at output 96, which completes the loop. The quiescent current regulation loop includes a path including drain terminal 26 of transistor 22, output 98, quiescent current regulation amplifier 32, current control circuit 73 which generates a current I_{R}, current mirror 88, and the drain to source of transistor 22, wherein the drain of transistor 22 is connected to output 98 which completes the loop.

In addition, LDO voltage regulators in accordance with embodiments of the present invention occupy a reduced area.

Although specific embodiments have been disclosed herein, it is not intended that the invention be limited to the disclosed embodiments. Those skilled in the art will recognize that modifications and variations can be made without departing from the spirit of the invention. For example, field effect transistors 40, 42, 62, 64, 70, 72, 80, 216, 218, 220, 226, 224, and 22 can be replaced with bipolar transistors or the LDO voltage regulator may be implemented using combinations of bipolar and field effect transistors. It is intended that the invention encompass all such modifications and variations as fall within the scope of the appended claims.

What is claimed is:

1. A low dropout voltage regulator, comprising:
an error amplifier having a plurality of input terminals and an output terminal, a first input terminal of the plurality of input terminals of the error amplifier coupled for receiving a reference voltage; and
an output driver having a plurality of input terminals and a plurality of outputs, a first input terminal of the plurality of input terminals of the output driver coupled to the output terminal of the error amplifier, a first output of the plurality of outputs of the output driver coupled to a second input terminal of the plurality of inputs of the error amplifier, a second input terminal of the plurality of input terminals of the output driver coupled for receiving an input signal.

2. The low dropout voltage regulator of claim 1, wherein the error amplifier comprises:
a pair of transistors differentially configured, wherein a first transistor of the pair of transistors has a control electrode and first and second current carrying electrodes, wherein the control electrode of the first transistor serves as the first input of the error amplifier and the second transistor of the pair of transistors has a control electrode and first and second current carrying electrodes, the control electrode of the second transistor serves as the second input of the error amplifier; and
a first current mirror having first and second terminals, the first terminal of the first current mirror coupled to the first current carrying electrode of the first transistor and the second terminal of the first current mirror coupled to the first current carrying electrode of the second transistor.

3. The low dropout voltage regulator of claim 2, wherein the error amplifier further comprises a frequency compensation network having first and second terminals, the first terminal of the frequency compensation network coupled to the first current carrying electrode of the second transistor and to the second terminal of the first current mirror.

4. The low dropout voltage regulator of claim 3, wherein the output driver comprises:
a second current mirror having a first input and first and second outputs; and
a current control circuit having first and second inputs and first and second conduction terminals, the first input of the current control circuit serving as the first input of the output driver and the first conduction terminal coupled to the first output of the second current mirror.

5. The low dropout voltage regulator of claim 4, wherein the output driver further comprises a voltage divider network having first and second terminals and a node, the first terminal of the voltage divider network coupled to the second output of the second current mirror and the node coupled to the control electrode of the second transistor of the pair of transistors.

6. The low dropout voltage regulator of claim 5, wherein the second current mirror comprises:
a third transistor having a control electrode and first and second current carrying electrodes, the control electrode of the third transistor coupled to the first conduction terminal of the current control circuit to form the first output of the second current mirror; and
a fourth transistor having a control electrode and first and second current carrying electrodes, the control electrode of the fourth transistor coupled to the control electrode of the third transistor, and the first current carrying electrode of the fourth transistor serving as the second output of the second current mirror.

7. The low dropout voltage regulator of claim 6, wherein the second current mirror further comprises:
a first resistor having first and second terminals, the first terminal coupled to the second current carrying electrode of the third transistor; and
a second resistor having first and second terminals, the first terminal coupled to the control electrodes of the third and fourth transistors, and the second terminal coupled to the second terminal of the first resistor and to the second current carrying electrode of the fourth transistor, the second terminals of the first and second resistors and the second current carrying electrode of the fourth transistor configured to serve as the second input of the output driver.

8. The low dropout voltage regulator of claim 7, wherein the output driver further comprises a quiescent current regulation amplifier having first and second inputs and an output, the first input of the quiescent current regulation amplifier coupled to the second current carrying electrode of the fourth transistor, the second input of the quiescent regulation amplifier coupled to the first terminal of the voltage divider network, and the output of the quiescent current regulation amplifier coupled to a second input of the current control circuit.

9. The low dropout voltage regulator of claim 8, wherein the quiescent current regulation amplifier further comprises means for generating an offset voltage.

10. The low dropout voltage regulator of claim 8, wherein the quiescent regulation amplifier further comprises:
a third current mirror having first and second current conducting terminals, the first current conducting terminal coupled to the second input of the current control circuit; and
a fourth current mirror having first, second, and third current conducting terminals, the first current conducting terminal of the fourth current mirror coupled to the first current conducting terminal of the third current mirror, the second current conducting terminal of the fourth current mirror coupled to the second current conducting terminal of the third current mirror, and the third current conducting terminal of the fourth current mirror coupled to the second input of the output driver.

11. The low dropout voltage regulator of claim 10, wherein the third current mirror comprises:
a fifth transistor having a control electrode and first and second current carrying electrodes, the first current carrying electrode of the fifth transistor serving as the first current conducting terminal of the third current mirror; and
a sixth transistor having a control electrode and first and second current carrying electrodes, the first current carrying electrode of the sixth transistor serving as the second current conducting terminal of the third current mirror and the control electrode of the sixth transistor coupled to the control electrode of the fifth transistor.

12. The low dropout voltage regulator of claim 11, wherein the width to length ratios of the fifth and sixth transistors are configured such that the width to length ratio of the fifth transistor is greater than the width to length ratio of the sixth transistor, and a drain current of the fifth transistor is substantially equal to a drain current of the sixth transistor.

13. A method for regulating a voltage, comprising:
operating a voltage regulator under control of an output voltage regulation loop in response to the voltage regulator not being in a low dropout region; and
operating the voltage regulator under control of a quiescent current regulation loop in response to the voltage regulator being in a low dropout region.

14. The method of claim 13, wherein operating the voltage regulator under control of the output regulation loop in response to the voltage regulator not being in a low dropout region comprises:
generating a feedback voltage at a first output;
generating a first current in response to comparing the feedback voltage with a first reference voltage; and
generating a second current in response to the first current, wherein a portion of the second current flows towards a second output.

15. The method of claim 14, wherein operating the voltage regulator under control of the output regulation loop in response to the voltage regulator not being in a low dropout region comprises:
setting a voltage at a first node to an input voltage level in response to a drain to source voltage of a transistor being greater than an offset voltage of a quiescent current regulation amplifier;
amplifying the first current; and wherein
generating the second current in response to the first current includes mirroring the first current, wherein the second current flows from a current carrying terminal of a transistor.

16. The method of claim 14, further including increasing the second current in response to the feedback voltage being lower than the reference voltage and decreasing second current in response to the feedback voltage being greater than the reference voltage.

17. The method of claim 13, wherein operating the voltage regulator under control of a quiescent current regulation loop in response to the voltage regulator being in a low dropout region includes regulating a second current so that a drain to source voltage of a transistor substantially equals an offset voltage of a quiescent current regulation amplifier and reducing a first current in response to a light load or no load coupled to the voltage regulator.

18. The method of claim 13, wherein operating the voltage regulator under control of the output regulation loop in response to the voltage regulator not being in a low dropout region comprises:
generating a feedback voltage at an output;
generating a first current in response to comparing the feedback voltage with a first reference voltage; and
generating a second current in response to the first current, wherein a portion of the second current flows towards the output.

19. The method of claim 18, wherein operating the voltage regulator under control of a quiescent current regulation loop in response to the voltage regulator being in a low dropout region includes regulating the second current so that a drain to source voltage of a transistor substantially equals an offset voltage of a quiescent current regulation amplifier and reducing the first current in response to a light load or no load coupled to the voltage regulator.

20. A method for regulating a voltage, comprising:
in response to operating in a first mode:
comparing a feedback voltage with a reference voltage to generate a comparison signal;
generating a first current in response to the comparison signal;
mirroring the first current to generate a mirrored current that flows towards an output of a voltage regulator to adjust the output voltage of the voltage regulator and the feedback voltage; and
in response to operating in a second mode:
generating a first voltage at the output in response the mirrored current;
using a quiescent current regulation amplifier to generate a current adjust voltage in response to an input voltage and the first voltage appearing at first and second input terminals of the quiescent current amplifier;
generating the first current in response to the current adjust voltage; and
mirroring the first current to form a mirrored current that serves as a drain to source current of a transistor coupled to the output of the voltage regulator.

21. The method of claim 20, further including using the mirrored current to set the drain to source voltage of the transistor substantially equal to an offset voltage associated with the quiescent current regulation amplifier.
